(19) United States
(12) Patent Application Publication
(10) Pub. No.: US 2010/0283167 A1
(43) Pub. Date: Nov. 11, 2010

(54) METHODS OF MAKING CERAMIC FIBERS AND BEADS

(76) Inventor: Gang Qi, Oakdale, MN (US)

Correspondence Address: 3M INNOVATIVE PROPERTIES COMPANY, PO BOX 33427, ST. PAUL, MN, 55133-3427, US

(21) Appl. No.: 12/809,404

(22) PCT Filed: Dec. 19, 2008
(86) PCT No.: PCT/US08/87593

§ 371 Date: Jun. 18, 2010

Related U.S. Application Data
(60) Provisional application No. 61/017,487, filed on Dec. 28, 2007.

(51) Int. Cl. B29B 9/00; D01D 5/18

(52) U.S. Cl. 264/8; 264/210.8

(57) ABSTRACT

Methods of making ceramic fibers and beads are disclosed.

### TECHNICAL FIELD

The present disclosure relates to methods of forming inorganic ceramic fibers and beads.

### BACKGROUND

Some inorganic ceramic compositions can not be practically drawn into fibers using conventional fiber forming techniques due to the working temperature, a relatively steep viscosity profile, or the crystallization behavior of the inorganic oxide ceramic melt. Although some techniques could be used in an attempt to form fibers from these inorganic ceramic compositions, the techniques would most likely encounter one or more processing obstacles due to the working temperature, the relatively steep viscosity profile, and/or the crystallization behavior of the inorganic oxide ceramic melt. For example, liquid shearing and fiberization of a jetting stream of the inorganic ceramic composition leaving a crucible could possibly be achieved by blowing or jetting a high velocity fluid (e.g., high velocity air jetting) onto the jetting stream. Another possible technique might be to attempt to sufficiently undercool an inorganic oxide ceramic melt within a crucible or at a crucible orifice so as to reach a fiber forming viscosity, and subsequently attempt to draw the melt using conventional fiber drawing techniques. In yet another possible technique, a jetting stream of inorganic composition could potentially be stabilized by forming an outer sheath (e.g., a carbon sheath) around the jetting stream of a given inorganic ceramic composition to as to stabilize the jetting stream sufficiently so that the jetting stream can be formed into fibers using a conventional fiber drawing process. However, as noted above, these possible fiber-forming techniques would most likely fail due to the working temperature, the relatively steep viscosity profile, and/or the crystallization behavior of the inorganic oxide ceramic melt.

In addition, it is difficult to form beads from some inorganic compositions using conventional bead forming techniques due again to the working temperature, the relatively steep viscosity profile, and/or the crystallization behavior of the inorganic oxide ceramic melt.

There is a need in the art for methods of making ceramic fibers that are not capable of being drawn in conventional fiber drawing processes. Further, there is a need in the art for methods of making ceramic beads that are not capable of being formed in conventional bead forming processes.

### SUMMARY OF THE INVENTION

The present invention is directed to ceramic fibers and beads, as well as methods of making ceramic fibers and beads. The disclosed methods are particularly suitable for making ceramic fibers and beads from compositions that are (i) not capable of being drawn into fibers using conventional fiber drawing techniques or (ii) not capable of being formed into beads using conventional bead forming techniques. The disclosed methods may be used to form a variety of ceramic fibers and beads from compositions comprising one or more metal oxides, one or more rare earth metal oxides, and combinations thereof.

In one exemplary embodiment, the method of making ceramic fibers comprises ejecting molten inorganic material onto an outer surface of a rotatable member having an axis of rotation, the ejecting step forming one or more pools of undercooled liquid comprising the molten inorganic material on the outer surface; and rotating the rotatable member along the axis of rotation to provide a centrifugal force to the undercooled liquid positioned on the outer surface so as to dislodge at least a portion of the undercooled liquid from the outer surface so as to form the ceramic fibers from dislodged undercooled liquid. As a portion of the undercooled liquid dislodges from the upper surface of the rotatable member, the dislodged portion pulls additional undercooled liquid from a given pool of undercooled liquid and orients/draws the additional undercooled liquid into an ceramic fiber above the outer surface of the rotatable member. One or more topographical features may be positioned along the outer surface of the rotatable member, wherein the one or more topographical features enable the formation of the one or more pools of undercooled liquid along an outer surface of the rotatable member. The ceramic fibers formed in this exemplary method may be further processed, such as heat treated, to modify the properties of the ceramic fibers (e.g., form a polycrystalline structure).

In another exemplary embodiment, the method of making ceramic fibers comprises forming one or more pools of undercooled liquid comprising molten inorganic material on an outer surface of a rotatable member having an axis of rotation; and spinning the rotatable member along the axis of rotation to centrifugally dislodge at least a portion of the undercooled liquid from the outer surface so as to form ceramic fibers from the dislodged undercooled liquid. This exemplary method of making ceramic fibers may further comprise heating the inorganic material to a melt temperature above a liquidus temperature of the inorganic material to form a homogenous molten inorganic material, jetting a stream of the homogenous molten inorganic material from an orifice onto the outer surface to form the one or more pools of undercooled inorganic material, and following fiber formation, optionally heat treating the ceramic fibers to from polycrystalline fibers. In some exemplary methods, the axis of rotation extends through the outer surface of the rotatable member, and the outer surface of the rotatable member is an upper surface of the rotatable member.

In yet a further exemplary embodiment, the method of making ceramic fibers comprises providing a rotatable member having an outer surface and an axis of rotation; while rotating the rotatable member, ejecting molten inorganic material having a melt temperature above a liquidus temperature of the inorganic material through an orifice and onto the outer surface of the rotatable member; forming one or more pools of undercooled liquid comprising the inorganic material on the outer surface, wherein at least a portion of each pool is undercooled liquid but not completely solidified; and providing a shear force to the undercooled liquid, due to rotation of the outer surface, so as to draw or stretch at least a portion of the undercooled liquid into ceramic fibers.

The present invention is further directed to methods of making ceramic beads. In one exemplary embodiment, the method of making ceramic beads comprises forming one or more pools of undercooled liquid comprising molten inorganic material on an outer surface of a rotatable member having an axis of rotation; spinning the rotatable member along the axis of rotation to centrifugally dislodge at least a portion of the undercooled liquid from a remaining portion of solidified undercooled liquid stuck to the outer surface; and maintaining the rotatable member at a spin rate that causes the dislodged portion of undercooled liquid to roll along the outer surface, forming one or more ceramic beads from the dislodged undercooled liquid.

The present invention is even further directed to ceramic fibers and beads formed by the methods disclosed herein. The ceramic fibers and beads are useful in a variety of applications including, but not limited to, insulation, sensing and coupling applications, reinforcement, and high temperature applications.

These and other features and advantages of the present invention will become apparent after a review of the following detailed description of the disclosed embodiments and the appended claims.

### BRIEF DESCRIPTION OF THE DRAWINGS

The present invention is further described with reference to the appended figures, wherein:

FIG. 1A depicts an exemplary apparatus suitable for making ceramic fibers and beads according to the present invention;

FIG. 1B depicts a top view of an upper surface of the rotatable member in the exemplary apparatus shown in FIG. 1A as viewed in the direction of arrow A_{T} shown in FIG. 1A;

FIG. 1C depicts an exemplary cross-sectional view of the rotatable member in the exemplary apparatus shown in FIG. 1A as viewed perpendicular to rotational axis A_{R} shown in FIG. 1A;

FIG. 1D depicts another exemplary cross-sectional view of the rotatable member in the exemplary apparatus shown in FIG. 1A as viewed perpendicular to rotational axis A_{R} shown in FIG. 1A;

FIG. 2A depicts another exemplary apparatus suitable for making ceramic fibers and beads according to the present invention;

FIG. 2B depicts a side view of the rotatable member in the exemplary apparatus shown in FIG. 2A as viewed along axis of rotation A_{R} shown in FIG. 2A;

FIGS. 3A-3B depict a frontal view and a cross-sectional view of exemplary fibers formed by the methods of the present invention;

FIGS. 4A-4B depict a cross-sectional view and a surface view, respectively, of exemplary heat treated fibers formed by the methods of the present invention;

FIG. 5 depicts the IR transmission of exemplary LAZ material used to form exemplary fibers of the present invention; and

FIG. 6 depicts a view of exemplary beads formed by the methods of the present invention.

### DETAILED DESCRIPTION OF THE INVENTION

Although the present invention is herein described in terms of specific embodiments, it will be readily apparent to those skilled in this art that various modifications, rearrangements, and substitutions can be made without departing from the spirit of the invention. The scope of the present invention is thus only limited by the claims appended hereto.

The present invention is directed to ceramic fibers and beads, as well as methods of making ceramic fibers and beads. As used throughout the present application and claims:

“ceramic” refers to non-metal inorganic materials including amorphous material, glass, crystalline ceramic, glass-ceramic, nanocrystalline ceramic, and combinations thereof;

“amorphous material” refers to material derived from a melt and/or a vapor phase that lacks any long range crystal structure as determined by X-ray diffraction and/or has an exothermic peak corresponding to the crystallization of the amorphous material as determined by a DTA (differential thermal analysis) as determined by the test described herein entitled “Differential Thermal Analysis”;

“glass” refers to amorphous material exhibiting a glass transition temperature;

“glass-ceramic” refers to ceramics comprising crystals formed by heat-treating amorphous material;

“nanocrystalline ceramic” refers to ceramics comprising crystals having a largest dimension in the nanometer range (e.g., typically, less than about 500 nm and as low as 50 nm or lower);

“REO” refers to rare earth oxide(s);

“undercooling” refers to cooling a liquid below its freezing point without complete solidification or crystallization of the liquid; and

“undercooled” refers to liquid that is cooled below its freezing point without complete solidification or crystallization of the liquid.

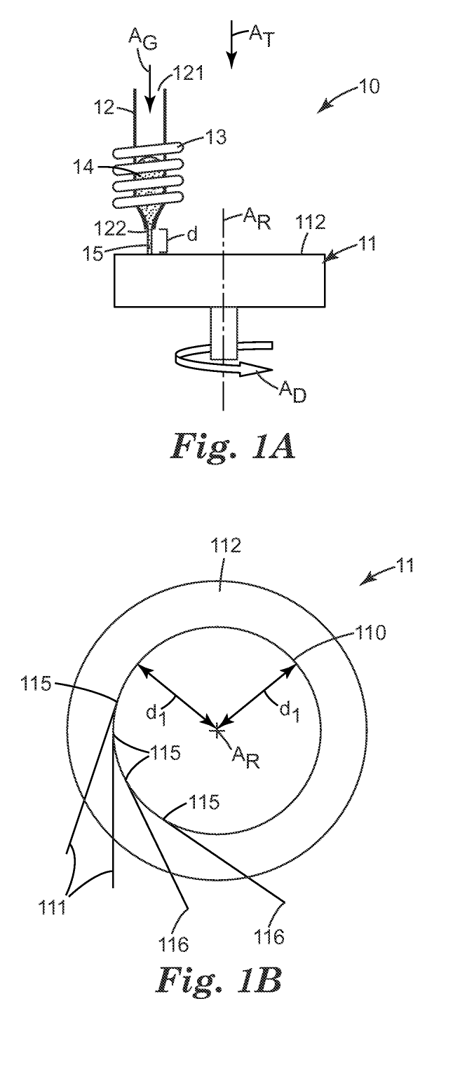

The disclosed methods for making ceramic fibers and beads may utilize an apparatus such as the exemplary apparatus shown in FIG. 1A. As shown in FIG. 1A, exemplary apparatus 10 comprises rotatable member 11 having an upper surface 112 and an axis of rotation A_{R} extending through upper surface 112; crucible 12 having a crucible inlet 121 and a crucible orifice (i.e., outlet) 122 positioned a distance, d, above upper surface 112; and heating coil 13 positioned around a portion of crucible 12.

As shown in FIG. 1A, rotatable member 11 rotates along axis of rotation A_{R} in a direction indicated by arrow A_{D}. In one desired embodiment, upper surface 112 of rotatable member 11 is substantially within a horizontal plane, and axis of rotation A_{R} extends perpendicular to the horizontal plane (as shown in FIG. 1A). Rotatable member 11 may rotate along axis of rotation A_{R} at a spinning rate (e.g., as measured in Hz) that varies depending on a number of process conditions discussed further below.

As shown in FIG. 1B, upper surface 112 of rotatable member 11 comprises one or more topographical features therein that enable the formation of one or more pools 115 of undercooled liquid along upper surface 112, wherein the one or more pools 115 of undercooled liquid comprise molten ceramic or ceramic precursor material 15. For example, as shown in FIG. 1B, upper surface 112 of rotatable member 11 may comprise one or more grooves 110 extending at least partially along upper surface 112. Exemplary groove 110 extends along a path that is at a substantially equal distance, d₁, from axis of rotation A_{R}. In this exemplary embodiment, discussed further below, one or more pools 115 of undercooled liquid are at least partially present within grooves 110 during a rotating step, and enable the formation of ceramic fibers 111 from dislodged portions of undercooled liquid from pools 115.

FIG. 1C provides a cross-sectional view of rotatable member 11 of exemplary apparatus 10 as viewed perpendicular to rotational axis A_{R}. As shown in FIG. 1C, exemplary groove 110 extends into upper surface 112 a depth d₂ and has a groove width of w₂. It should be noted that depth d₂ and groove width w₂ of exemplary groove 110 may vary as desired, and are not limited in any way other than by the dimensions of rotatable member 11. Typically, depth d₂ and groove width w₂ each independently range from about 0.1 mm to about 25 mm. Further, although exemplary groove 110 is shown as having a triangular shape (i.e., two side walls and a gap in upper surface 112), grooves in upper surface 112 may have any desired shape (e.g., circular, square, rectangular, etc.).

Further, the one or more topographical features capable of enabling the formation of one or more pools 115 of undercooled liquid along upper surface 112 do not have to be in the form of one or more grooves as shown in FIG. 1D. Any topographical feature may be used along an outer surface of a rotatable member (e.g., upper surface 112 of rotatable member 11 or outer surface 212 of rotatable member 21 discussed below) as long as the topographical feature(s) enables the formation of one or more pools 115 of undercooled liquid along the outer surface. Another exemplary outer surface configuration having a topographical feature thereon is shown in FIG. 1D.

As shown in FIG. 1D, a cross-sectional view of exemplary rotatable member 18 depicts an upper surface 112 comprising (i) a rim portion 185 extending around an outer perimeter of exemplary rotatable member 18 and (ii) an indentation 184 bound by upper surface portion 182 and side wall 181 extending along an outer periphery of upper surface portion 182. In this exemplary embodiment, indentation 184 extends along upper surface 112 a distance d₃ from axis of rotation A_{R}, while exemplary rotatable member 18 has an overall radius as shown by distance d₄. It should be noted that distance d₃ may have a length that varies as desired between greater than 0 to less than d₄.

Other possible topographical features that could be present on an outer surface of a given rotatable member include, but are not limited to, one or more pyramid-like structures, wells or grooves extending along or perpendicular to a rotational direction, an array of spikes or other protrusions extending along an outer surface of a given rotatable member. As discussed above, any topographical feature or combination of topographical features may be used along an outer surface of a rotatable member (e.g., upper surface 112 of rotatable member 11 or outer surface 212 of rotatable member 21 discussed below) as long as the topographical feature(s) enables the formation of one or more pools 115 of undercooled liquid along the outer surface.

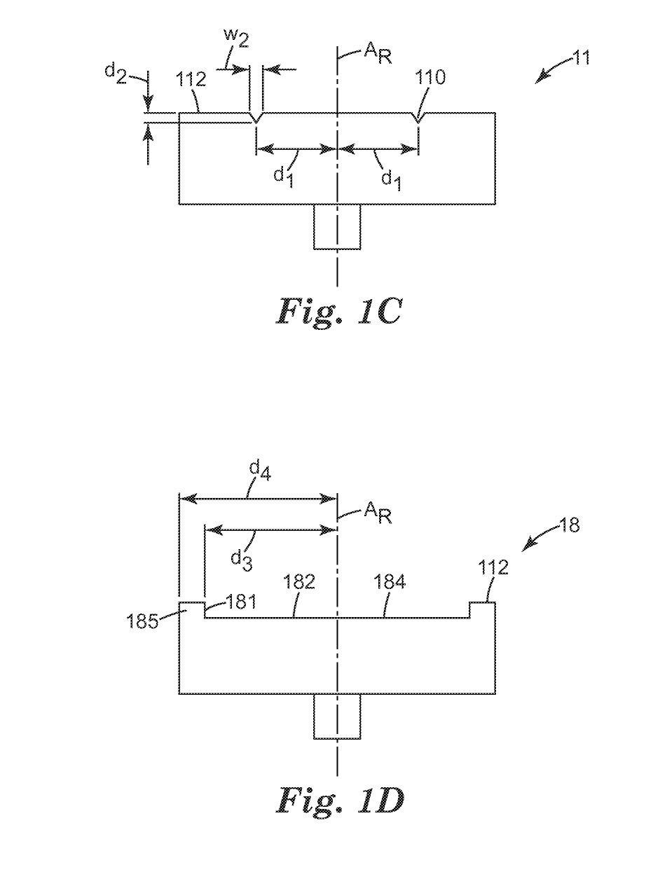

The disclosed methods for making glass fibers and beads may also utilize an apparatus such as exemplary apparatus shown in FIGS. 2A-2B. As shown in FIG. 2A, exemplary apparatus 20 comprises rotatable member 21 having an outer surface 212 and an axis of rotation A_{R} extending substantially parallel to outer surface 212; crucible 12 having a crucible inlet 121 and crucible orifice (i.e., outlet) 122 positioned a distance, d, above outer surface 212; and heating coil 13 positioned around a portion of crucible 12.

As shown in FIG. 2A, exemplary rotatable member 21 rotates along axis of rotation A_{R} in a direction indicated by arrow A_{D}. In one desired embodiment, as shown in FIG. 2A, outer surface 212 of rotatable member 21 is substantially parallel with axis of rotation A_{R} extending through an outer periphery 24 of rotatable member 21; however, it is to be understood that outer surface 212 of rotatable member 21 could also form an intersecting angle relative to axis of rotation A_{R} (e.g., a conically-shaped outer surface) or have some degree of curvature from along outer surface 212.

Exemplary rotatable member 21 comprises one or more topographical features capable of enabling the formation of one or more pools 115 of undercooled liquid along outer surface 212. In particular, exemplary rotatable member 21 comprises grooves 210 positioned along outer surface 212. Although grooves 210 are shown as being spaced from one another, it should be understood that any number of grooves 210 may be positioned along outer surface 212 from a single groove to a maximum number of grooves wherein the entire outer surface 212 is covered with grooves 210.

FIG. 2B provides a side view of rotatable member 21 of exemplary apparatus 20 as viewed along rotational axis A_{R}. As shown in FIG. 2B, exemplary grooves 210 extend into outer surface 212 a depth d₂ and has a groove width of w₂. As discussed above, depth d₂ and groove width w₂ of exemplary grooves 210 may vary as desired, and are not limited in any way other than by the dimensions of rotatable member 21. Further, exemplary grooves 210 may have any desired shape such as the above-described shapes (e.g., circular, square, rectangular, etc.).

Like rotatable member 21 of exemplary apparatus 20 discussed above, rotatable member 21 may rotate along axis of rotation A_{R} at a spinning rate that varies depending on a number of process conditions including, but not limited to, the composition of exemplary ceramic or ceramic precursor composition 14, whether fibers or beads are to be formed, the dimensions of rotatable member 11 or 21 and especially the dimensions of upper surface 112 of rotatable member 11 and outer surface 212 of rotatable member 21, the location along upper surface 112 of rotatable member 11 or outer surface 212 of rotatable member 21 at which molten ceramic or ceramic precursor material 15 contacts upper surface 112 or outer surface 212, the cooling rate of molten ceramic or ceramic precursor material 15 from the time molten ceramic or ceramic precursor material 15 exits crucible orifice 122 to the time at which at least a portion of molten ceramic or ceramic precursor material 15 reaches a fiber-forming viscosity on upper surface 112 of rotatable member 11 or outer surface 212 of rotatable member 21, etc. It can be desirable for the fiber-forming viscosity to be high enough for the molten ceramic or ceramic precursor material 15 to prevent or at least resist being formed into a bead or other spherical shape.

All of the above-mentioned factors that determine a desired rotational speed affect the degree of cooling of the one or more pools 115 of undercooled liquid along outer surface 212 or outer surface 212. The degree of the cooling of the one or more pools 115 of undercooled liquid along outer surface 212 or outer surface 212 is influenced by, for example, the melt temperature, the jet radiation (e.g., the amount and rate of heat radiated by jetting stream 15 shown in FIGS. 1A and 2A), the nature of the gasses present in a chamber surrounding a given apparatus, the wheel rotational speed, the wheel diameter, the wheel temperature, as well as the jet pinching position relative to the radius of the wheel as discussed above.

For example, for apparatus similar to those used in the example section below, rotatable member 11 rotates along axis of rotation A_{R} at a spinning rate of at least about 30 Hz, and more typically, at least about 50 Hz when forming ceramic fibers. For apparatus similar to those used in the example section below, rotatable member 11 rotates along axis of rotation A_{R} at a spinning rate of from about 1 to 5 Hz when forming ceramic beads.

Rotatable members and outer surfaces thereof (e.g., rotatable members 11 and 21, upper surface 112 and outer surface 212) may comprise a number of materials capable of withstanding the relatively high melt temperatures of the disclosed ceramic or ceramic precursor compositions. Suitable crucible materials include, but are not limited to, graphite; metals such as copper, molybdenum, platinum and platinum/rhodium; ceramics such as alumina and boron nitride (BN), and combinations thereof. Typically, rotatable members and outer surfaces thereof comprise a metal material such as copper or stainless steel. In one exemplary embodiment, rotatable members and outer surfaces thereof comprise copper such as C110 copper.

A detailed description of methods of making ceramic fibers and beads using apparatus such as exemplary apparatus 10 of FIGS. 1A-1B and exemplary apparatus 20 of FIGS. 2A-2B is provided below.

### Ceramic Fibers:

The present invention is directed to methods of making ceramic fibers. The methods of making ceramic fibers may include a number of steps such as melting an inorganic composition, jetting the molten inorganic composition, cooling the jetted inorganic composition, and fiber forming at least a portion of the inorganic composition into one or more fibers. The methods are particularly suitable for forming ceramic fibers from ceramic and ceramic precursor compositions that are incapable of being drawn into fibers using conventional fiber drawing processes. Such inorganic compositions typically exhibit relatively low viscosities near their melting point and tend to crystallize readily when cooled from a melting temperature. At the same time, during undercooling, it has been discovered that these compositions can yield undercooled liquids having a suitable viscosity for fiberization without crystallizing. Given adequate cooling time, such undercooled liquids convert to a polycrystalline ceramic (i.e. make the material non-fiberizable). However, the methods of the present invention apply shear force to the disclosed ceramic and ceramic precursor compositions so as to form ceramic fibers prior to complete solidification of the disclosed ceramic and ceramic precursor compositions.

Suitable ceramic and ceramic precursor compositions having the above-described properties (e.g., a fiber-forming viscosity during an undercooling step) typically include, but are not limited to, ceramic compositions comprising (i) a first metal oxide selected from the group consisting of Al₂O₃, CaO, CoO, Cr₂O₃, CuO, Fe₂O₃, HfO₂, MgO, MnO, Nb₂O₅, NiO, REO, Sc₂O₃, Ta₂O₅, TiO₂, V₂O₅, Y₂O₃, ZnO, ZrO₂, and complex metal oxides thereof, and (ii) at least one second metal oxide selected from the group consisting of Al₂O₃, Bi₂O₃, CaO, CoO, Cr₂O₃, CuO, Fe₂O₃, Ga₂O₃, HfO₂, MgO, MnO, Nb₂O₅, NiO, REO, Sc₂O₃, Ta₂O₅, TiO₂, V₂O₅, Y₂O₃, ZnO, ZrO₂, and complex metal oxides thereof, wherein the first metal oxide and the at least one second metal oxide are different from one another. More typically, the compositions contain no more than about 20 percent by weight (wt %) of SiO₂, B₂O₃, P₂O₅, TeO₂, PbO, GeO₂, or combinations thereof based on a total weight of the composition. When present, B₂O₃, GeO₂, P₂O₅, SiO₂, TeO₂, PbO and combinations thereof are typically added in the range of greater than 0 wt % to about 20 wt % (in some embodiments 0 to 15 wt %, or 0 to 10 wt %, or even 0 to 5 wt %) of the composition.

Examples of useful ceramic compositions for making fibers and beads according to the present disclosure include, but are not limited to, those comprising REO-TiO₂, REO-ZrO₂—TiO₂, REO-Al₂O₃, REO-Al₂O₃—ZrO₂, and REO-Al₂O₃—ZrO₂—SiO₂ and their precursors. Particularly useful ceramic compositions include those at or near an eutectic composition.

Other examples of useful ceramic compositions for making fibers and beads according to the present disclosure include, but are not limited to, (1) ceramic compositions comprising (i) a lanthanum oxide, (ii) a zirconium oxide, and (iii) either an aluminum oxide or a titanium oxide; and (2) ceramic compositions comprising (i) a lanthanum oxide, (ii) a zirconium oxide, (iii) aluminum oxide, and (iv) gadolinium oxide. In some ceramic compositions, the ceramic composition is substantially free of any silicates.

Other suitable ceramic compositions that may be formed into fibers using the methods of the present invention include, but are not limited to ceramic compositions disclosed in commonly owned U.S. patent applications having Ser. Nos. 10/211,577, 10/211,638, 10/211,034, 10/211,684, 10/358,772, 10/901,638, and 11/521,913, the subject matter of each of which is hereby incorporated herein by reference.

The amount of each metal oxide within a given ceramic composition may vary as desired. Typically, each metal oxide within a given ceramic composition, other than those described above that are present at a level of less than about 20 wt %, is present in an amount of at least about 5.0 wt % (or at least about 5.0 wt %, or at least about 10.0 wt % or at least about 15.0 wt %, or at least about 20.0 wt %) based on a total weight of the ceramic composition. In some embodiments, one metal oxide may represent a substantial portion of a given ceramic composition. For example, when lanthanum oxide, aluminum oxide or titanium oxide is present, each of the lanthanum oxide, aluminum oxide and titanium oxide is typically present in an amount of at least about 30 wt %, and typically ranges from about 30 wt % to about 60 wt % based on a total weight of the ceramic composition.

Other metal oxides may only represent a minor portion of a given ceramic composition. For example, when zirconium oxide or gadolinium oxide is present, each of the zirconium oxide and gadolinium oxide is typically present in an amount of less than about 20 wt %, and typically ranges from about 5 wt % to about 20 wt % based on a total weight of the ceramic composition.

Any of the above-described ceramic compositions may be formed into ceramic fibers as described herein. Referring to FIGS. 1A and 2A, exemplary ceramic or ceramic precursor composition 14 is heated to a melt temperature so as to desirably form a homogeneous molten inorganic composition. Desirably, the melt temperature is equal to or greater than a liquidus temperature of exemplary ceramic or ceramic precursor composition 14. Although the melt temperature will vary depending upon the given ceramic or ceramic precursor composition, melt temperatures typically range from about 1000° C. to about 2000° C., typically above 1250° C., more typically above 1500° C.

Exemplary ceramic or ceramic precursor composition 14 may be heated, for example, in a crucible, such as exemplary crucible 12. In one exemplary embodiment, exemplary crucible 12 comprises a graphite crucible; however, crucible 12 may comprise other high temperature materials including, but not limited to, those described above.

Exemplary ceramic or ceramic precursor composition 14 may be heated within exemplary crucible 12 via an external heat source, such as exemplary heating coil 13. Exemplary heating coil 13 may comprise any conventional heating element including, but not limited to, graphitic or metallic coils/elements. In one desired embodiment, exemplary heating coil 13 comprises a RF coil operatively adapted to heat exemplary ceramic or ceramic precursor composition 14 to a melt temperature equal to or greater than a liquidus temperature of exemplary ceramic or ceramic precursor composition 14.

In order to avoid undesirable reactivity of the molten ceramic or ceramic precursor composition, exemplary ceramic or ceramic precursor composition 14 is typically heated to a desired melt temperature within a controlled environment. Suitable controlled environments include, but are not limited to, an environment under vacuum, a nitrogen environment (e.g., typically at lower temperatures in the above-mentioned melt temperature range), and an inert gas environment. In one exemplary embodiment, helium (He) gas is used to provide an inert gas environment for the heating step. Other suitable inert gas environments include argon.

The oxide sources for forming the melt may be, for example, in the form of blended fine powders, for example, blended and granulated by first dry or wet milling, followed by optionally drying and granulating, or granulating, for example, by spray drying. The oxide sources for forming the melt may also be, for example, previously fused, and optionally may be subsequently crushed to provide granular of powdered feed. The oxide sources for forming the melt may also be, for example, previously spheroidized material made, for example, by plasma spraying or other flame forming techniques.

Once exemplary ceramic or ceramic precursor composition 14 is heated to a desired melt temperature, a jetting pressure may be applied onto exemplary ceramic or ceramic precursor composition 14 within crucible 12 via upper opening 121 of crucible 12 as shown in FIGS. 1A and 2A by arrow A_{G}. The jetting pressure forces exemplary ceramic or ceramic precursor composition 14 through orifice 122 of crucible 12 so as to form a jetting stream 15 of molten inorganic material. Although the amount of jetting pressure may vary depending on a number of process factors including, but not limited to, the ceramic or ceramic precursor composition, and the shape and size of orifice 122 (e.g., the diameter), typically, the amount of jetting pressure necessary to form a jetting stream 15 of molten inorganic material ranges from about 1224 to about 1428 gf/cm² (about 900 to about 1050 torr).

Although the shape and size of orifice 122 of crucible 12 may vary, typically, orifice 122 of crucible 12 has a circular cross-sectional shape with an orifice diameter ranging from about 0.30 to about 0.60 mm. Other possible orifice shapes include, but are not limited to, a rectangular shape, a square shape, and a triangular shape.

Jetting stream 15 of molten inorganic material travels a distance d from orifice 122 of crucible 12 to upper surface 112 of rotatable member 11 (or outer surface 212 of rotatable member 21). Typically, distance d ranges from about 10 mm to about 25 mm, but may vary depending on the composition of exemplary ceramic or ceramic precursor composition 14. As jetting stream 15 of molten inorganic material travels distance d from orifice 122 of crucible 12 to upper surface 112 of rotatable member 11 (or outer surface 212 of rotatable member 21), jetting stream 15 quickly cools due to (i) heat radiation of jetting stream 15, as well as (ii) heat transfer between jetting stream 15 and the surrounding gaseous environment (e.g., He), rapidly increasing the viscosity of jetting stream 15. Once jetting stream 15 of molten inorganic material strikes upper surface 112 of rotatable member 11 (or outer surface 212 of rotatable member 21), jetting stream 15 is further cooled (and the viscosity further increased) due to heat transfer between jetting stream 15 and upper surface 112 of rotatable member 11 (or outer surface 212 of rotatable member 21).

Once jetting stream 15 contacts upper surface 112 of rotatable member 11 (or outer surface 212 of rotatable member 21) spinning at a desired spinning rate, one or more pools 115 of molten inorganic material form on upper surface 112 (or outer surface 212), wherein at least a portion of the one or more pools 115 is undercooled liquid, but not completely solidified (i.e., there may be partial solidification and/or crystallization). It is believed that a portion of each pool 115 that is in contact with upper surface 112 of rotatable member 11 (or outer surface 212 of rotatable member 21) quickly solidified and at least temporarily sticks to upper surface 112 (or outer surface 212). An upper portion of each pool 115 that is not in contact with upper surface 112 (or outer surface 212) remains in a liquid state. This upper portion (i.e., the undercooled liquid) of each pool 115 reaches a viscosity which is suitable for fiber forming. As upper surface 112 (or outer surface 212) rotates, a shear force is provided to the undercooled liquid, causing a portion 116 of pool 115 to dislodge from a remaining portion of pool 115 stuck to upper surface 112 (or outer surface 212). As the dislodged portion 116 of pool 115 disengages from the remaining portion of pool 115, the dislodged portion 116 pulls additional material from pool 115 so as to form fibers 111 between dislodged portion 116 and the remaining portion of pool 115. In other words, fiber formation of fibers 111 primarily takes place above upper surface 112 of rotatable member 11 (or outer surface 212 of rotatable member 21) as opposed to on upper surface 112 of rotatable member 11 (or outer surface 212 of rotatable member 21).

In some embodiments of the present invention, the rotatable member (e.g., rotatable members 11 and 21) may be cooled or maintained at a substantially constant temperature during the deposition step (i.e., deposition of molten inorganic material onto upper surface 112 of rotatable member 11). The rotatable member may be cooled or maintained at a substantially constant temperature via any conventional method including, but not limited to, providing a hollow rotatable member operatively adapted to circulate a cooling medium (e.g., water) through one or more inner cavities of the rotatable member, blowing air or some other fluid onto an outer surface of the rotatable member (e.g., upper surface 112 or outer surface 212), or a combination thereof.

In addition to controlling the cooling of molten inorganic material on an outer surface of a rotatable member, the amount of molten inorganic material deposited onto an outer surface of a rotatable member can be controlled so that crystallization is avoided and sufficient undercooled liquid material is available to enable drawing of the undercooled liquid into fibers as discussed above. The deposition rate for a given inorganic composition will vary depending on a number of factors including, but not limited to, the composition, the rate of cooling, the wheel rotational speed, the wheel diameter, the wheel temperature, the jet pinching (i.e., contact) position relative to the radius of the wheel, etc.

Although not shown in the figures, it should be understood that multiple crucibles 12 may be used to form multiple jetting streams 15 of molten inorganic material, wherein the multiple jetting streams 15 of molten inorganic material. Typically, as discussed above, the multiple jetting streams 15 of molten inorganic material contact upper surface 112 of rotatable member 11 (or outer surface 212 of rotatable member 21) to form multiple pools 115 of undercooled liquid that subsequently form fibers as discussed above.

In one exemplary embodiment, the method of making ceramic fibers comprises ejecting molten inorganic material 15 onto upper surface 112 of rotatable member 11 having an axis of rotation A_{R} that extends through upper surface 112, the ejecting step forming one or more pools 115 of undercooled liquid comprising the molten inorganic material on upper surface 112; and rotating rotatable member 11 to provide a centrifugal force to the undercooled liquid positioned on upper surface 112 so as to dislodge at least a portion 116 of the undercooled liquid from upper surface 112 so as to form ceramic fibers 111 from dislodged undercooled liquid. In this exemplary embodiment, at least a portion of the inorganic material in contact with upper surface 112 of rotatable member 11 remains on upper surface 112 during and following fiber formation. As discussed above, this exemplary method is particularly suitable wherein the molten inorganic material comprises one or more metal oxides and/or REOs that collectively have a viscosity/temperature profile that prevents the molten inorganic material from being conventionally drawn into fibers.

In another exemplary embodiment, the method of making ceramic fibers comprises providing a rotatable member 11 having an upper surface 112 and an axis of rotation A_{R} extending substantially perpendicularly through upper surface 112; while rotating rotatable member 11, ejecting molten inorganic material 15 having a melt temperature above a liquidus temperature of the inorganic material through an orifice 122 and onto upper surface 112 of rotatable member 11; forming one or more pools 115 of undercooled liquid comprising the molten inorganic material on upper surface 112, wherein at least a portion of the one or more pools 115 is undercooled liquid but not solidified; and providing a shear force to the undercooled liquid, due to rotation of upper surface 112, so as to draw or stretch at least a portion of the undercooled liquid into ceramic fibers. In this exemplary embodiment, after the ejecting step, the method may further comprise contacting the molten inorganic material with a forced cooling medium (e.g., He) in order to cool the molten inorganic material prior to contacting upper surface 112.

In yet another exemplary embodiment, the method of making ceramic fibers comprises forming one or more pools 115 of undercooled liquid comprising molten inorganic material on an upper surface 112 of a rotatable member 11 having an axis of rotation A_{R} that extends through upper surface 112; and spinning rotatable member 11 along axis of rotation A_{R} to centrifugally dislodge at least a portion 116 of the undercooled liquid from upper surface 112 so as to form one or more ceramic fibers 111 from the dislodged undercooled liquid. In this exemplary embodiment, the method may further comprise heating the ceramic or ceramic precursor material to a melt temperature above a liquidus temperature of the inorganic material to form a homogenous molten inorganic material; jetting a stream 15 of the homogenous molten inorganic material from an orifice 122 onto upper surface 112 to form the one or more pools 115 of undercooled inorganic material; and following fiber formation, heat treating the ceramic fibers to from polycrystalline fibers.

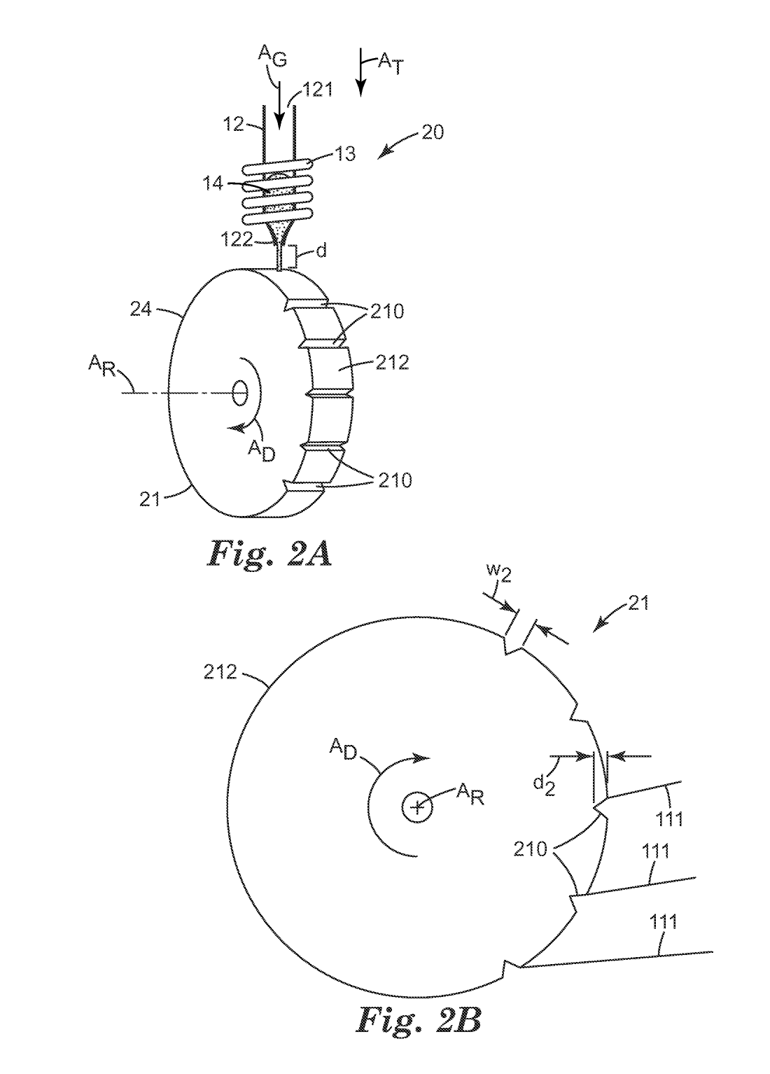

The resulting ceramic fibers of the present invention typically have an aspect ratio of at least about 1:1000, a fiber length of from about 10 mm to about 200 mm, and an average fiber diameter ranging from about 5 μm to about 20 μm. Typically, the resulting ceramic fibers have a substantially circular cross-sectional configuration and a substantially constant diameter extending along a length of a given fiber. (See, for example, the exemplary ceramic fibers formed in Example 1 and shown in FIGS. 3A-3B.)

Following the above-described fiber formation step, the resulting fibers may be further processed to alter one or more properties of the fibers. For example, the resulting ceramic fibers may be heat treated to from polycrystalline fibers. Typical heat treating conditions may comprise, for example, heating the resulting ceramic fibers at a heat treating temperature ranging from about 750° C. to about 1500° C. for a period of time ranging from about 5 minutes to about 60 or more minutes.

In some cases, polycrystalline structures in the ceramic fibers may be directly generated (1) during the above-described fiber forming step (e.g., during the drawing step as dislodged portion 116 pulls additional material from pool 115 so as to form fibers 111 between dislodged portion 116 and the remaining portion of pool 115), (2) during a subsequent cooling step, or (3) both (1) and (2) so that an additional heat treating step is unnecessary. It is believed that compositions having a greater instability against crystallization are more likely to exhibit such behavior.

The resulting ceramic fibers of the present invention may be completely glassy, crystalline, and/or partially crystalline. Any crystalline phases present in the ceramic fibers according to the present invention may form spontaneously during the fiber formation process or may be intentionally induced by a heat treatment after the fiber forming step. The degree of crystallization induced during a heat treatment process will depend on the desired fiber properties (e.g., strength, hardness etc.), as well as the heat treatment temperature, time, and the composition of the ceramic fibers.

Typically, the ceramic fibers have an average crystal size of less than 1 micrometer, less than 0.5 micrometer, or even less than 0.3 micrometer. In some embodiments, the ceramic fibers according to the present invention have an average crystal size of less than about 200 nm, or about 100 nm, or even about 50 nm (i.e., nanocrystalline structure).

### Ceramic Beads:

Exemplary apparatus 10 of FIGS. 1A-1B and exemplary apparatus 20 of FIGS. 2A-2B may also be utilized to form ceramic beads. In one exemplary embodiment, the method of making ceramic beads comprises forming one or more pools 115 of undercooled liquid comprising molten inorganic material on an upper surface 112 of rotatable member 11 having an axis of rotation A_{R} that extends through the upper surface 112; spinning rotatable member 11 along axis of rotation A_{R} to centrifugally dislodge at least a portion of the undercooled liquid from a remaining portion of solidified undercooled liquid stuck to upper surface 112; and maintaining rotatable member 11 at a spin rate that causes the dislodged portion of undercooled liquid to roll along upper surface 112, forming one or more ceramic beads from the dislodged undercooled liquid.

The methods of forming ceramic beads may be used to form beads from any of the above-described ceramic or ceramic precursor compositions comprising one or more metal oxides. In one desired embodiment, ceramic beads are formed from an ceramic or ceramic precursor composition comprising (i) lanthanum oxide and zirconium oxide, and optionally (ii) aluminum oxide or titanium oxide. In another desired embodiment, ceramic beads are formed from an ceramic or ceramic precursor composition comprising (i) lanthanum oxide, (ii) zirconium oxide, (iii) aluminum oxide, and (iv) gadolinium oxide.

The methods of making ceramic beads differ from the above-described methods of forming ceramic fibers in a couple of ways. For example, rotatable member 11 (or rotatable member 20) is typically rotated at a lower spinning rate when forming ceramic beads compared to the above-described spinning rate used to form ceramic fibers. Typically, rotatable member 11 rotates along axis of rotation A_{R} at a spinning rate of from about 1 Hz to about 5 Hz when forming ceramic beads using an apparatus such as the apparatus used in the examples below.

Further, in some embodiments, it may be desirable to change the rotational speed during the process of forming ceramic beads. For example, the rotational speed may begin at a relatively high speed (e.g., 5 Hz), then change to a lower speed (e.g., 1 Hz), and subsequently return to the relatively high speed (e.g., 5 Hz). The change in rotational speed may help with supercooling of molten inorganic material, dislodging of a portion of the pool material, or both.

Like the above-described methods of forming ceramic fibers, the methods of forming ceramic beads may further comprise heating the ceramic material to a melt temperature above a liquidus temperature of the ceramic or ceramic precursor material to form a homogenous molten inorganic material; jetting a stream 15 of the homogenous molten inorganic material from an orifice 122 onto upper surface 112 (or an outer surface 212) to form one or more pools 115 of undercooled inorganic material; and following bead formation, heat treating the ceramic beads to from polycrystalline beads using heat treating conditions similar to those described above. In other embodiments, a heat treatment step is unnecessary for forming polycrystalline beads due to crystalline formation during a cooling step.

The resulting ceramic beads typically have a substantially spherical shape and an average diameter ranging from about 0.5 mm to about 3.0 mm. Further, the resulting ceramic beads have a crystalline structure similar to the fibers described above. In particular, the ceramic beads typically have an average crystal size of less than 1 micrometer, less than 0.5 micrometer, or even less than 0.3 micrometer. In some embodiments, the ceramic beads have an average crystal size of less than about 200 nm, or about 100 nm, or even about 50 nm (i.e., nanocrystalline structure).

The present invention is described above and further illustrated below by way of examples, which are not to be construed in any way as imposing limitations upon the scope of the invention. On the contrary, it is to be clearly understood that resort may be had to various other embodiments, modifications, and equivalents thereof which, after reading the description herein, may suggest themselves to those skilled in the art without departing from the spirit of the present invention and/or the scope of the appended claims.

### EXAMPLES

### Example 1

A batch composition was prepared from the components as shown in Table 1 below.

TABLE 1
Ceramic Fiber Batch Composition

| Component | Wt % |
|---|---|
| SiO₂ | 0 |
| Al₂O₃ | 34.44 |
| La₂O₃ | 48.77 |
| ZrO₂ | 16.79 |

An apparatus similar to exemplary apparatus 10 shown in FIG. 1 was used to prepare ceramic fibers from the LAZ composition shown in Table 1 using process parameters as shown in Table 2 below.

TABLE 2
Ceramic Fiber Process Parameters

| Parameter | Setting |
|---|---|
| Crucible orifice diameter | 0.4 mm |
| Rotatable wheel composition | Copper C110 |
| Rotatable wheel diameter | 17.8 cm (7 in) |
| Groove configuration | 15.7/cm (40/in) |
| Groove depth | 0.5 to 1.0 mm |
| Spinning rate | 33 Hz |
| Chamber pressure | 407.8-679.8 gf/cm² |
| | (300-500 torr) |
| Jetting pressure | 1223.6-1359.5 gf/cm² |
| | (900-1000 torr) |
| Environment | He gas |
| Melt temperature | 1850-1950° C. |

The ceramic fiber composition shown in Table 1 was heated in a graphite crucible to the melt temperature to form a homogenous liquid melt. The liquid melt was forced through a graphite crucible orifice at a jetting pressure to form a liquid jet stream. As the liquid jet stream exited the crucible orifice, the liquid jet stream was cooled via radiation (i.e., radiation of heat from the liquid jet stream) and He gas contact, which rapidly decreased the viscosity of the liquid jet stream. The liquid jet stream contacted the rotatable wheel spinning at the above-mentioned spinning rate to form a pool of undercooled liquid. The portion of the liquid jet stream that contacted the rotatable wheel surface quickly solidified and stuck to the wheel surface. An upper portion of the undercooled liquid positioned on the rotatable wheel surface was still in a liquid state, and rapidly reached a viscosity suitable for fiber forming. Due to centrifugal force, a small portion of the undercooled liquid dislodged from a remaining portion of undercooled liquid and the solidified portion of the inorganic material stuck to the rotatable wheel surface. As the small portion of undercooled liquid dislodged from the spinning rotatable wheel, the small portion pulled a fine fiber from the remaining portion of undercooled liquid, forming a fine fiber of the inorganic composition.

The resulting fibers had a fiber diameter ranging from about 5 μm to about 20 μm, and a fiber length ranging from about 5 to about 200 mm. Further, the resulting fibers did not have a fine tail having a fiber diameter of less than 3 μm, and therefore were non-respirable fibers. FIGS. 3A-3B depict the fiber geometry of the exemplary fibers formed in Example 1.

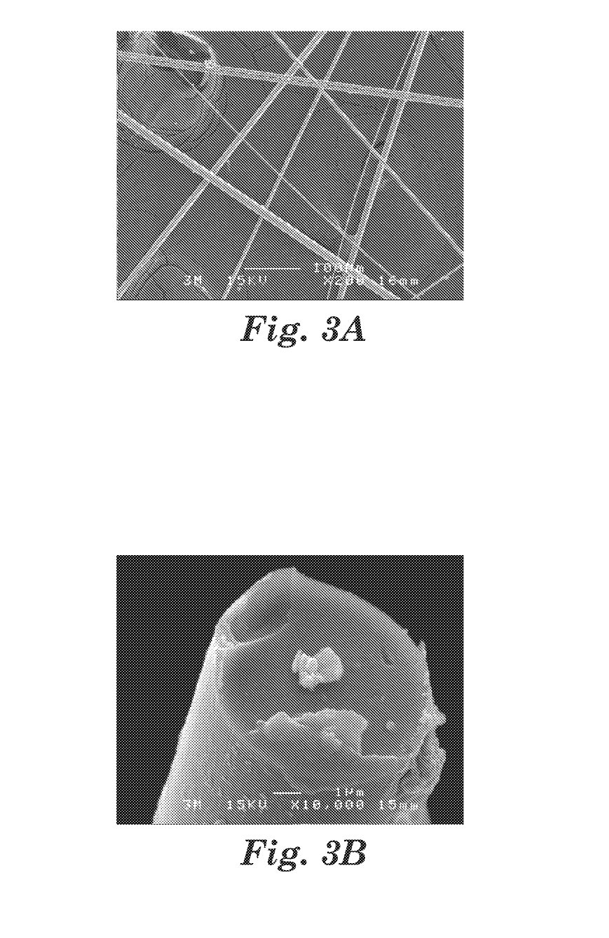

The fibers were heat treated at 1250° C. for 30 minutes to form fibers having a microcrystalline structure as shown in FIGS. 4A-4B. FIG. 4A provides a cross-sectional view of a heat treated fiber and FIG. 4B provides a view of the fiber surface of the heat treated fiber. Both figures provide a view of grains in the nanometer range.

The tensile strength of the fibers was found to be in the range of 1.2 GPa to 2.5 GPa. Additional tensile data is provided in Table 3 below.

TABLE 3
Tensile Data for Pre-Heat Treated Ceramic Fibers

| | | Strain at Break |
|---|---|---|
| Fiber Diameter | Peak Stress (Mpa) | (%) |
| 12.8 | 1993 | 2.72 |
| 12.8 | 2456 | 4.38 |
| 10.0 | 1279 | 0.63 |
| 9.1 | 1633 | 1.90 |
| 9.8 | 1808 | 1.97 |

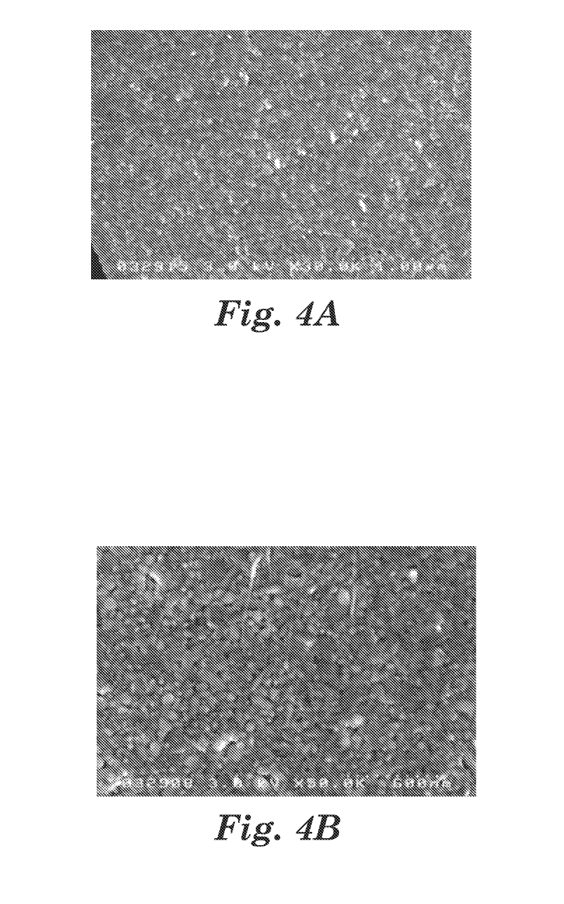

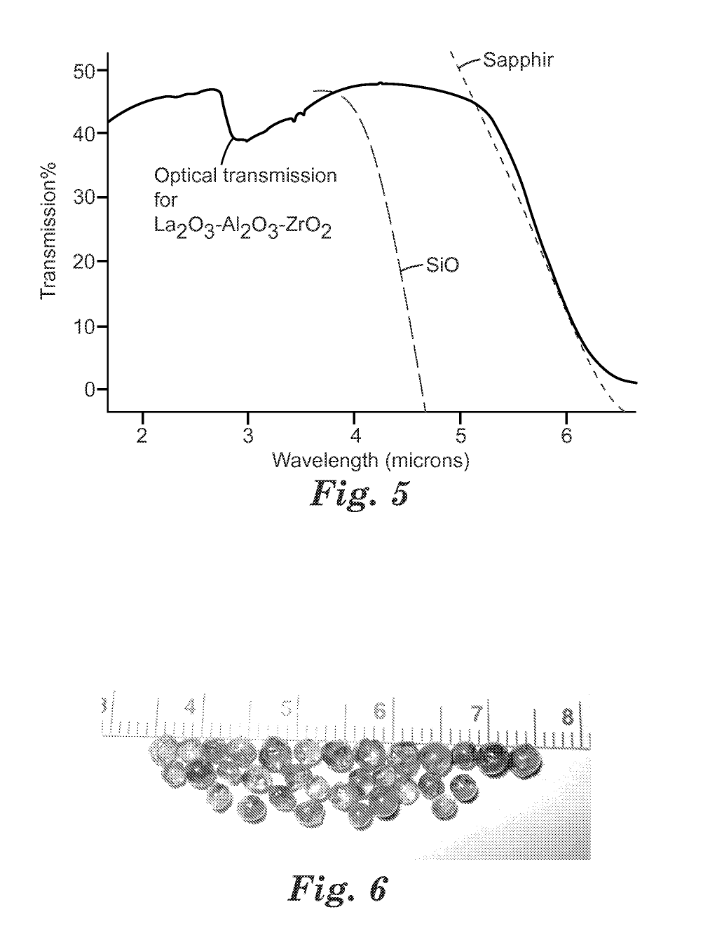

The heat treated fibers were also found to have good optical properties. The IR transmission of the bulk LAZ material was observed and is graphically depicted in FIG. 5. Fibers formed from the LAZ material can be used as IR fiber for IR imaging and sensing, as well as other optical applications.

### Example 2

A batch composition was prepared from the components as shown in Table 4 below.

TABLE 4
Ceramic Fiber Batch Composition

| Component | Wt % |
|---|---|
| SiO₂ | 0 |
| TiO₂ | 49.50 |
| La₂O₃ | 38.80 |
| ZrO₂ | 11.70 |

Ceramic fibers having the LZT composition as shown in Table 4 were prepared using the apparatus and method steps as described in Example 1. The resulting fibers had a fiber diameter ranging from about 5 μm to about 20 μm, and a fiber length ranging from about 10 to about 200 mm. Further, the resulting fibers did not have a fine tail having a fiber diameter of less than 3 μm, and therefore were non-respirable fibers.

The resulting fibers also had a relatively high reflective index of about 2.0 at 630 nm. The fibers can be used in numerous applications requiring high refractive index fibers including, but not limited to, sensing and coupling application, such as gyroscope sensing, laser coupling and LED coupling.

### Example 3

A batch composition was prepared from the components as shown in Table 5 below.

TABLE 5
Ceramic Fiber Batch Composition

| Component | Wt % |
|---|---|
| SiO₂ | 0 |
| La₂O₃ | 33.00 |
| Al₂O₃ | 38.50 |
| ZrO₂ | 18.50 |
| Gd₂O₃ | 10.00 |

Ceramic fibers having the LAZG composition as shown in Table 4 were prepared using the apparatus as described in Example 1 and the following process conditions as shown in Table 6 below.

TABLE 6
Ceramic Fiber Process Parameters

| Parameter | Setting |
|---|---|
| Crucible orifice diameter | 0.45 mm |
| Rotatable wheel composition | Copper C110 |
| Rotatable wheel diameter | 3.2 cm (1.25 in) |
| Groove configuration | Single groove |
| Groove depth | 0.5 to 1.0 mm |
| Spinning rate | 60-70 Hz |
| Chamber pressure | 475.8 gf/cm² (350 torr) |
| Jetting pressure | 1427.5 gf/cm² (1050 torr) |
| Environment | He gas |
| Melt temperature | 1840-1880° C. |
| Distance from crucible | 10-25 mm |
| bottom to wheel upper | |
| surface | |

The resulting fibers had a fiber diameter ranging from about 5 μm to about 20 μm, and a fiber length ranging from about 10 to about 200 mm. Further, the resulting fibers did not have a fine tail having a fiber diameter of less than 3 μm, and therefore were non-respirable fibers.

### Example 4

Ceramic beads having the LAZG composition as shown in Table 5 were prepared using the apparatus as described in Example 1 and the following process conditions as shown in Table 7 below.

TABLE 7
Ceramic Fiber Process Parameters

| Parameter | Setting |
|---|---|
| Crucible orifice diameter | 0.55-0.60 mm |
| Rotatable wheel composition | Copper C110 |
| Rotatable wheel diameter | 6.4 cm (2.5 in) |
| Groove configuration | Single groove |
| Groove depth | 0.5 to 1.0 mm |
| Spinning rate | 5 Hz |
| Chamber pressure | 475.8 gf/cm² (350 torr) |
| Jetting pressure | 1427.5 gf/cm² (1050 torr) |
| Environment | He gas |
| Melt temperature | 1850° C. |
| Distance from crucible | 10-25 mm |
| bottom to wheel upper | |
| surface | |

The liquid melt was forced through a graphite crucible orifice at a jetting pressure to form a liquid jet stream. As the liquid jet stream exited the crucible orifice, the liquid jet stream was cooled via radiation and He gas contact, which rapidly decreased the viscosity of the liquid jet stream. The liquid jet stream contacted the rotatable wheel spinning at the above-mentioned spinning rate to form one or more pools of undercooled liquid. The portion of the liquid jet stream that contacted the rotatable wheel surface quickly solidified and stuck to the wheel surface. An upper portion of the undercooled liquid positioned on the rotatable wheel surface was still in a liquid state, and rapidly reached a viscosity suitable for bead forming. Due to centrifugal force, a small portion of the undercooled liquid dislodged from a remaining portion of undercooled liquid (i.e., the solidified portion of the inorganic material stuck to the rotatable wheel surface). As the small portion of undercooled liquid dislodged from the remaining portion of undercooled liquid, the small portion began to roll along an upper surface of the rotatable member, forming a glass bead.

The resulting beads had a substantially spherical shape with a bead diameter ranging from about 0.5 mm to about 2.5 mm or greater.

While the specification has been described in detail with respect to specific embodiments thereof, it will be appreciated that those skilled in the art, upon attaining an understanding of the foregoing, may readily conceive of alterations to, variations of, and equivalents to these embodiments. Accordingly, the scope of the present invention should be assessed as that of the appended claims and any equivalents thereto.

1. A method of making ceramic fibers comprising:
ejecting molten inorganic material onto an outer surface of a rotatable member having an axis of rotation, said ejecting step forming one or more pools of undercooled liquid comprising the molten inorganic material on the outer surface; and
rotating the rotatable member along the axis of rotation to provide a centrifugal force to the undercooled liquid positioned on the outer surface so as to dislodge at least a portion of the undercooled liquid from the outer surface so as to form the ceramic fibers from dislodged undercooled liquid.

2. The method of claim 1, wherein the outer surface of the rotatable member has one or more topographical features therein that enable formation of the one or more pools of undercooled liquid along the outer surface.

3. The method of claim 2, wherein the one or more topographical features comprise one or more grooves extending at least partially along a path that is at a substantially equal distance from the axis of rotation, and the one or more pools of undercooled liquid are at least partially present within the grooves during said rotating step.

4. The method of claim 1, wherein fiber formation takes place above the outer surface of the rotatable member as opposed to on the outer surface of the rotatable member.

5. The method of claim 1, wherein at least a portion of the inorganic material in contact with the outer surface of the rotatable member remains on the outer surface during and following fiber formation.

6. The method of claim 1, further comprising:
after said ejecting step, contacting the molten inorganic material with a forced cooling medium in order to cool the molten inorganic material prior to contacting the outer surface.

7. The method of claim 1, wherein the molten inorganic material comprises (i) a first metal oxide selected from the group consisting of Al₂O₃, CaO, CoO, Cr₂O₃, CuO, Fe₂O₃, HfO₂, MgO, MnO, Nb₂O₅, NiO, REO, Sc₂O₃, Ta₂O₅, TiO₂, V₂O₅, Y₂O₃, ZnO, ZrO₂, and complex metal oxides thereof, and (ii) at least one second metal oxide selected from the group consisting of Al₂O₃, Bi₂O₃, CaO, CoO, Cr₂O₃, CuO, Fe₂O₃, Ga₂O₃, HfO₂, MgO, MnO, Nb₂O₅, NiO, REO, Sc₂O₃, Ta₂O₅, TiO₂, V₂O₅, Y₂O₃, ZnO, ZrO₂, and complex metal oxides thereof, wherein the first metal oxide and the at least one second metal oxide are different from one another.

8. The method of claim 7, wherein the molten inorganic material contains no more than about 20 percent by weight (wt %) SiO₂, B₂O₃, P₂O₅, TeO₂, PbO, GeO₂, or any combination thereof based on a total weight of the molten inorganic material.

9. The method of claim 1, wherein the molten inorganic material comprises (i) a lanthanum oxide, (ii) a zirconium oxide, and (iii) either an aluminum oxide or a titanium oxide, and the molten inorganic material comprises less than 20 wt % of SiO₂, B₂O₃, P₂O₅, TeO₂, PbO, GeO₂, or any combination thereof based on a total weight of the molten inorganic material.

10. The method of claim 9, wherein the molten inorganic material comprises aluminum oxide and gadolinium oxide.

11. The method of claim 1, wherein the ceramic fiber comprises a glass fiber.

12. The method of claim 1, wherein the ceramic fiber comprises a nanocrystalline fiber.

13. The method of claim 1, further comprising:
heat treating the ceramic fiber to from polycrystalline fibers.

14. The method of claim 1, wherein the ceramic fibers have a substantially circular cross-sectional configuration and a substantially constant diameter extending along a length of the fiber

15. The method of claim 1, wherein the ceramic fibers have an aspect ratio of at least about 1:1000, a fiber length of from about 10 mm to about 200 mm, and an average fiber diameter ranging from about 5 μm to about 20 μm.

16. A method of making ceramic fibers comprising:
forming one or more pools of undercooled liquid comprising molten inorganic material on an outer surface of a rotatable member having an axis of rotation; and
spinning the rotatable member along the axis of rotation to centrifugally dislodge at least a portion of the undercooled liquid from the outer surface so as to form one or more ceramic fibers from the dislodged undercooled liquid.

17. The method of claim 16, wherein the axis of rotation extends through the outer surface.

18. The method of claim 16, further comprising:
heating the inorganic material to a melt temperature above a liquidus temperature of the inorganic material to form a homogenous molten inorganic material;
jetting a stream of the homogenous molten inorganic material from an orifice onto the outer surface to form the one or more pools of undercooled inorganic material; and
following fiber formation, optionally heat treating the ceramic fibers to from polycrystalline fibers.

19. A method of making ceramic beads comprising:
forming one or more pools of undercooled liquid comprising molten inorganic material on an outer surface of a rotatable member having an axis of rotation;
spinning the rotatable member along the axis of rotation to centrifugally dislodge at least a portion of the undercooled liquid from a remaining portion of solidified undercooled liquid stuck to the outer surface; and
maintaining the rotatable member at a spin rate that causes the dislodged portion of undercooled liquid to roll along the outer surface, forming one or more ceramic beads from the dislodged undercooled liquid.

20. The method of claim 19, further comprising:
changing the spin rate to (i) increase a cooling rate of the molten inorganic material, (ii) dislodge a portion of the undercooled liquid from the outer surface, or (iii) both (i) and (ii).

21. The method of claim 19, further comprising:
heating the inorganic material to a melt temperature above a liquidus temperature of the inorganic material to form a homogenous molten inorganic material;
jetting a stream of the homogenous molten inorganic material from an orifice onto the outer surface to form the one or more pools of undercooled inorganic material; and
following bead formation, optionally heat treating the ceramic beads to from polycrystalline beads.

22. The method of claim 19, wherein the molten inorganic material comprises (i) a first metal oxide selected from the group consisting of Al₂O₃, CaO, CoO, Cr₂O₃, CuO, Fe₂O₃, HfO₂, MgO, MnO, Nb₂O₅, NiO, REO, Sc₂O₃, Ta₂O₅, TiO₂, V₂O₅, Y₂O₃, ZnO, ZrO₂, and complex metal oxides thereof, and (ii) at least one second metal oxide selected from the group consisting of Al₂O₃, Bi₂O₃, CaO, CoO, Cr₂O₃, CuO, Fe₂O₃, Ga₂O₃, HfO₂, MgO, MnO, Nb₂O₅, NiO, REO, Sc₂O₃, Ta₂O₅, TiO₂, V₂O₅, Y₂O₃, ZnO, ZrO₂, and complex metal oxides thereof, wherein the first metal oxide and the at least one second metal oxide are different from one another.

23. The method of claim 22, wherein the molten inorganic material contain no more than about 20 percent by weight (wt %) SiO₂, B₂O₃, P₂O₅, TeO₂, PbO, GeO₂, or any combination thereof based on a total weight of the molten inorganic material.

24. The method of claim 19, wherein the inorganic material comprises (i) lanthanum oxide and zirconium oxide, and optionally (ii) aluminum oxide or titanium oxide.

25. The method of claim 19, wherein the ceramic beads have a substantially spherical shape and an average diameter ranging from about 0.5 mm to about 5.0 mm.
